(19) United States
(12) Patent Application Publication
(10) Pub. No.: US 2025/0029783 A1
(43) Pub. Date: Jan. 23, 2025

(54) MULTILAYER CERAMIC CAPACITOR

(71) Applicant: Murata Manufacturing Co., Ltd., Nagaokakyo-shi (JP)

(72) Inventors: Kazuhiro NISHIBAYASHI, Nagaokakyo-shi (JP); Yuko KAWASAKI, Nagaokakyo-shi (JP)

(21) Appl. No.: 18/905,344

(22) Filed: Oct. 3, 2024

Related U.S. Application Data
(63) Continuation of application No. PCT/JP2023/037365, filed on Oct. 16, 2023.

(30) Foreign Application Priority Data
Dec. 19, 2022 (JP) 2022-202429

(51) Int. Cl. H01G 4/012; H01G 4/232; H01G 4/30

(52) U.S. Cl. CPC H01G 4/012; H01G 4/2325; H01G 4/30

(57) ABSTRACT

A multilayer ceramic capacitor includes end-surface-exposure internal electrodes, lateral-surfaces-exposure internal electrodes, first dielectric layers each having the end-surface-exposure internal electrode thereon, and second dielectric layers each having the lateral-surface-exposure internal electrode thereon. At least one of each first and second dielectric layer includes an auxiliary internal electrode on a portion adjacent to one surface at which the internal electrode is not exposed. The auxiliary internal electrode is spaced apart from the internal electrode, is exposed at the one surface, and is opposed to a lead-out portion of the internal electrode different from and adjacent to the internal electrode. A through hole penetrates through the auxiliary internal electrode and includes a same dielectric as that of the dielectric layers to connect the dielectric layers in contact with the auxiliary internal electrode.

### CROSS REFERENCE TO RELATED APPLICATIONS

This application claims the benefit of priority to Japanese Patent Application No. 2022-202429 filed on Dec. 19, 2022 and is a Continuation Application of PCT Application No. PCT/JP2023/037365 filed on Oct. 16, 2023. The entire contents of each application are hereby incorporated herein by reference.

### 1. BACKGROUND OF THE INVENTION

### Field of the Invention

The present invention relates to multilayer ceramic capacitors.

### 2. DESCRIPTION OF THE RELATED ART

There is a known multilayer ceramic capacitor including a multilayer body in which a plurality of dielectric layers each having thereon an internal electrode exposed at end surfaces of the multilayer body are alternately laminated with a plurality of dielectric layers each having thereon an internal electrode exposed at lateral surfaces of the multilayer body, end-surface electrodes disposed on the end surfaces, and lateral-surface electrodes disposed on the lateral surfaces (see Japanese Unexamined Patent Application, Publication No. 2010-98052).

### SUMMARY OF THE INVENTION

In such a multi-terminal multilayer ceramic capacitor, the directions in which the internal electrodes extend are different from one layer to another. Therefore, at the time of sintering, directions in which shrinkage takes place are different from one layer to another, and a difference in internal stress between the layers becomes large particularly in lead-out regions in which the lead-out portions of the internal electrodes are disposed. In this case, peeling-off of one layer from another is more likely to be caused.

Example embodiments of the present invention provide multilayer ceramic capacitor each capable of reducing a difference in internal stress and preventing or reducing peeling-off of one layer from another.

A multilayer ceramic capacitor according to an example embodiment of the present invention includes a multilayer body including a plurality of dielectric layers laminated in a lamination direction and each having an internal electrode disposed thereon, the multilayer body including two main surfaces respectively provided on both sides in the lamination direction, two lateral surfaces respectively provided on both sides in a width direction intersecting with the lamination direction, and two end surfaces respectively provided on both sides in a length direction intersecting with the lamination direction and the width direction, end-surface external electrodes respectively provided on the end surfaces of the multilayer body, and lateral-surface external electrodes respectively provided on the lateral surfaces of the multilayer body, the internal electrode including end-surface-exposure internal electrodes exposed at the end surfaces, and lateral-surfaces-exposure internal electrodes exposed at the lateral surfaces, each of the end-surface-exposure internal electrodes including a counter portion and a lead-out portion that extends from the counter portion, each of the lateral-surface-exposure internal electrodes including a counter portion and a lead-out portion that extends from the counter portion, the counter portion of the end-surface-exposure internal electrode and the counter portion of the lateral-surface-exposure internal electrode being opposed to each other, the dielectric layers including first dielectric layers each including the end-surface-exposure internal electrode thereon, and second dielectric layers each including the lateral-surface-exposure internal electrode thereon, the first dielectric layers and the second dielectric layers being alternately laminated with each other, in which at least one of each first dielectric layer or each second dielectric layer includes an auxiliary internal electrode on a portion adjacent to at least one of the lateral surface or the end surface at which the internal electrode on the at least one of each first dielectric layer or each second dielectric layer is not exposed, the auxiliary internal electrode is spaced apart from the internal electrode on the at least one of each first dielectric layer or each second dielectric layer, is exposed at the at least one of the lateral surface or the end surface, and is opposed to the lead-out portion of the internal electrode that is different from and adjacent in the lamination direction to the internal electrode on the at least one of each first dielectric layer or each second dielectric layer, the auxiliary internal electrode includes a through hole which penetrates through the auxiliary internal electrode in the lamination direction and in which a same dielectric as that of the dielectric layers is provided, and the dielectric in the through hole establishes connection between the dielectric layers that are in contact with the auxiliary internal electrode and that are respectively located toward the two main surfaces.

Multilayer ceramic capacitors according to example embodiments of the present invention are capable of reducing a difference in internal stress and preventing or reducing peeling-off of one layer from another.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a cross-sectional view of the multilayer ceramic capacitor 1 according to the first example embodiment of the present invention, taken along line II-II in FIG. 1.

FIG. 3 is a cross-sectional view of the multilayer ceramic capacitor 1 according to the first example embodiment of the present invention taken along the line III-III in FIG. 1.

FIG. 4 is a cross-sectional view of the multilayer ceramic capacitor 1 according to the first example embodiment of the present invention, taken along an end-surface-exposure internal electrode 15A.

FIG. 5 is a cross-sectional view of the multilayer ceramic capacitor 1 according to the first example embodiment of the present invention, taken along a lateral-surface-exposure internal electrode 15B.

FIG. 6 is a diagram illustrating a step of producing a multilayer body 2, included in a method of manufacturing the multilayer ceramic capacitor 1.

FIG. 7 is a flowchart illustrating the method of manufacturing the multilayer ceramic capacitor 1.

FIG. 8 is a cross-sectional view of a multilayer ceramic capacitor 100 according to a second example embodiment of the present invention, taken along line II-II in FIG. 1.

FIG. 9 is a cross-sectional view of the multilayer ceramic capacitor 100 according to the second example embodiment of the present invention, taken along the line III-III in FIG. 1.

### DETAILED DESCRIPTION OF THE EXAMPLE EMBODIMENTS

### First Example Embodiment

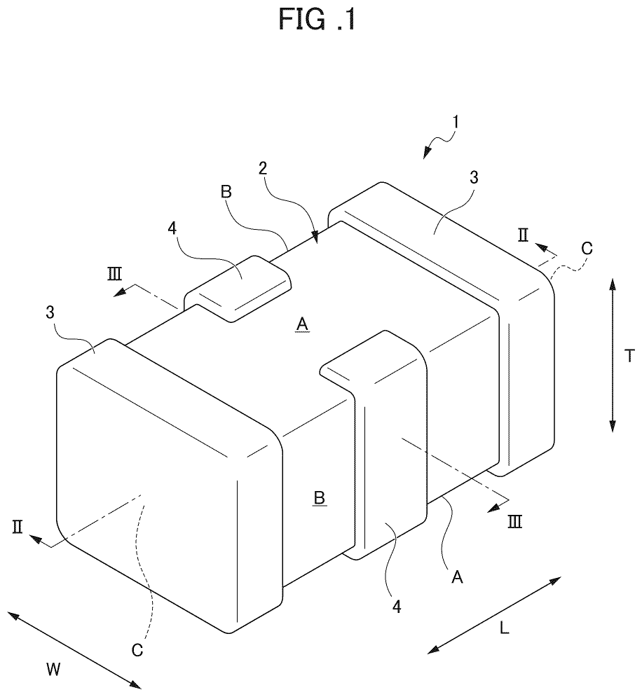

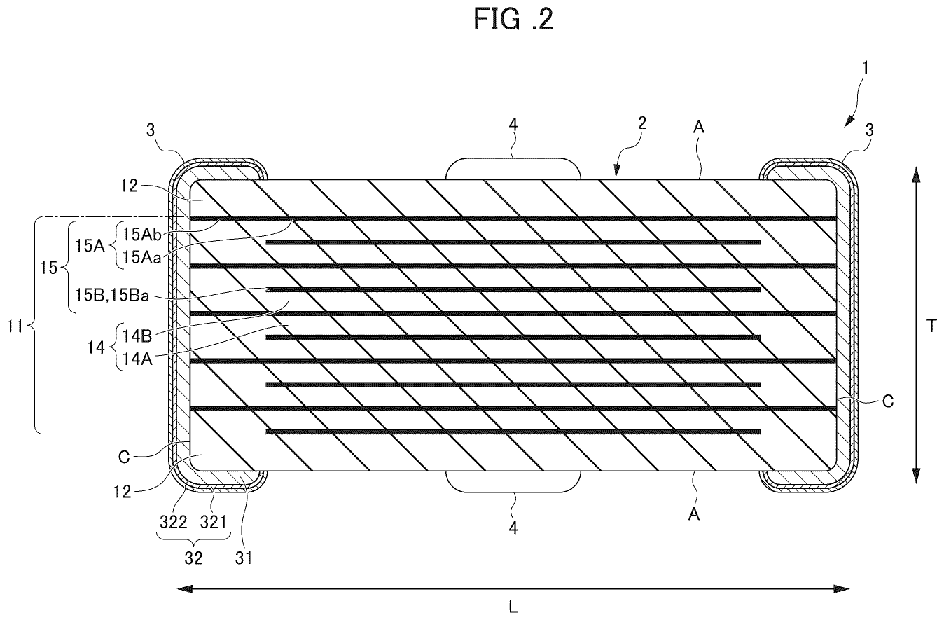

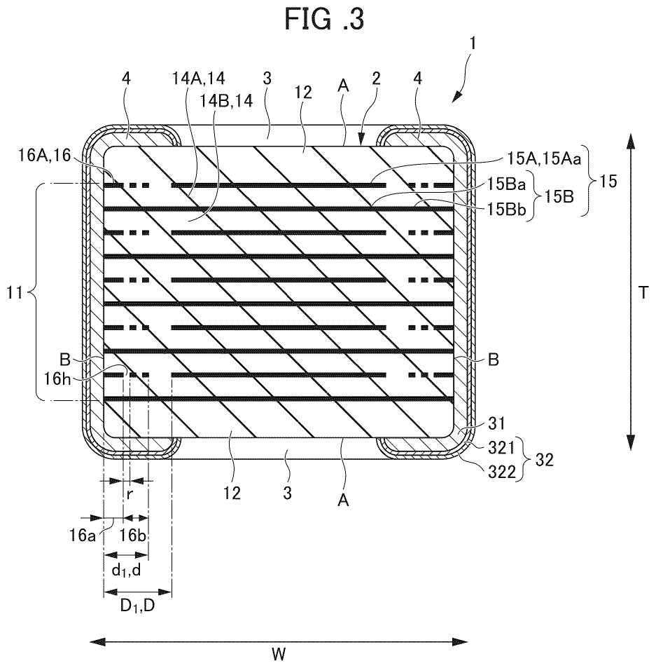

A multilayer ceramic capacitor 1 according to a first example embodiment of the present invention will be described below. FIG. 1 is a schematic perspective view of the multilayer ceramic capacitor 1. FIG. 2 is a cross-sectional view of the multilayer ceramic capacitor 1 according to the first example embodiment, taken along line II-II in FIG. 1. FIG. 3 is a cross-sectional view of the multilayer ceramic capacitor 1 according to the first example embodiment, taken along line III-III in FIG. 1.

### Multilayer Ceramic Capacitor 1

The multilayer ceramic capacitor 1 has a three-terminal structure and includes a multilayer body 2, end-surface external electrodes 3 provided on both end surfaces C of the multilayer body 2 in a length direction L, and lateral-surface external electrodes 4 provided on both lateral surfaces B of the multilayer body 2 in a width direction W. The multilayer body 2 includes an inner layer portion 11 in which dielectric layers 14 and internal electrodes 15 are laminated, and outer layer portions 12.

The following terms are used to indicate directions in the multilayer ceramic capacitor 1 in the present specification. A direction in which the dielectric layers 14 and the internal electrodes 15 are laminated in the multilayer ceramic capacitor 1 is referred to as a lamination direction T. A direction which intersects with the lamination direction T and in which the pair of end-surface external electrodes 3 are arranged is referred to as the length direction L. A direction intersecting with both the length direction L and the lamination direction T is referred to as the width direction W. Preferably, the lamination direction T, the length direction L, and the width direction W are orthogonal to one another.

Furthermore, in the following description, among the six outer surfaces of the multilayer body 2, a pair of outer surfaces provided on both sides in the lamination direction T are referred to as main surfaces A, a pair of outer surfaces extending in the lamination direction T and provided on both sides in the width direction W are referred to as lateral surfaces B, and a pair of outer surfaces extending in the lamination direction T and provided on both sides in the length direction L are referred to as end surfaces C.

### Multilayer Body 2

The multilayer body 2 includes the inner layer portion 11 and the outer layer portions 12 that are disposed on both sides of the inner layer portion 11 in the lamination direction T. The multilayer body 2 preferably has rounded corners and ridges. The corner is where three surfaces of the multilayer body 2 meet one another, and the ridge is where two surfaces of the multilayer body 2 meet each other.

### Inner Layer Portion 11

In the inner layer portion 11, the plurality of dielectric layers 14 and the plurality of internal electrodes 15 are laminated in the lamination direction T.

### Dielectric Layer 14

The dielectric layers 14 are made of a ceramic material.

As the ceramic material, for example, a dielectric ceramic including BaTiO₃ as a main component is used. Alternatively, a material including, in addition to the main component, at least one subcomponent selected from a Mn compound, a Fe compound, a Cr compound, a Co compound, a Ni compound, or the like may be used.

### Internal Electrode 15

The internal electrodes 15 are preferably made of a metal material, representative examples of which include Ni, Cu, Ag, Pd, a Ag—Pd alloy, Au, etc.

The internal electrodes 15 include a plurality of end-surface-exposure internal electrodes 15A and a plurality of lateral-surface-exposure internal electrodes 15B that are alternately arranged with each other. The end-surface-exposure internal electrode 15A and the lateral-surface-exposure internal electrode 15B are collectively referred to as the internal electrode(s) 15 when it is unnecessary to particularly distinguish from each other.

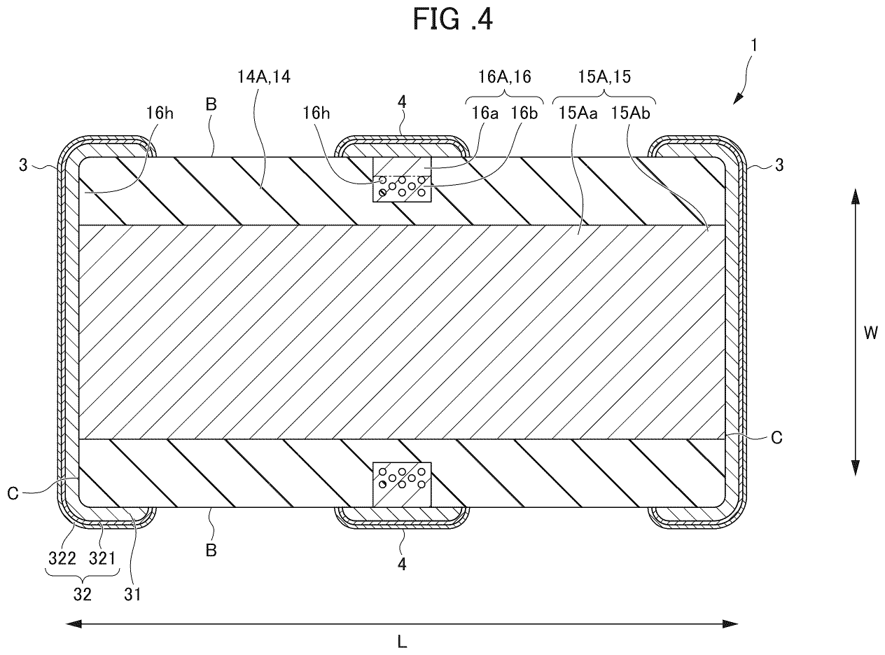

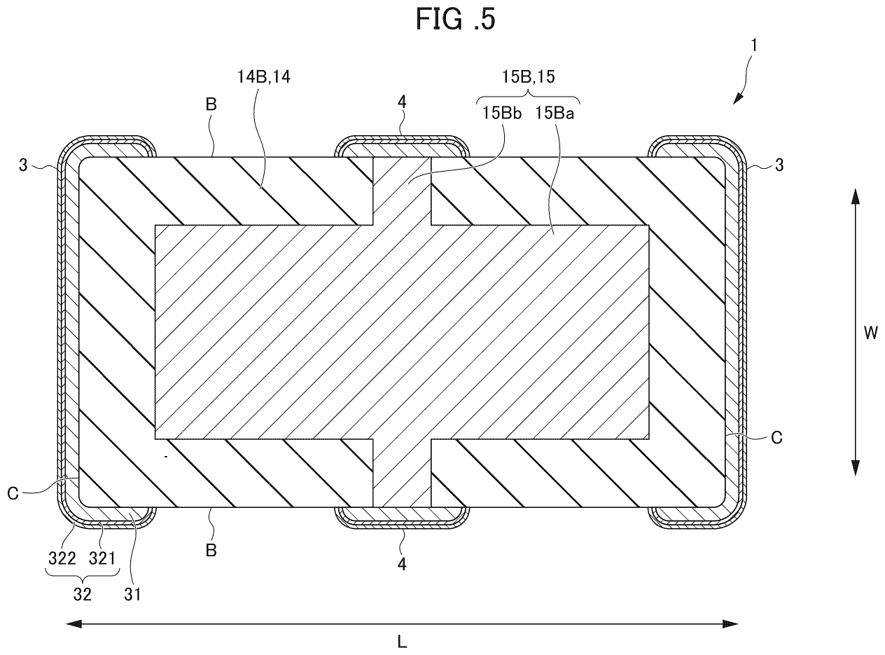

FIG. 4 is a cross-sectional view of the multilayer ceramic capacitor 1, taken along the end-surface-exposure internal electrode 15A. FIG. 5 is a cross-sectional view of the multilayer ceramic capacitor 1, taken along the lateral-surface-exposure internal electrode 15B.

### End-Surface-Exposure Internal Electrode 15A

As illustrated in FIG. 4, each end-surface-exposure internal electrode 15A extends between the end surfaces C in the length direction L of the multilayer body 2 and is spaced apart from both lateral surfaces B in the width direction W by a certain distance. Each end-surface-exposure internal electrode 15A includes an end-surface counter portion 15Aa located in a central portion between both end surfaces C, and end-surface lead-out portions 15Ab extending from the end-surface counter portion 15Aa to both end surfaces C, respectively. The end-surface lead-out portions 15Ab extend to and are exposed at the end surfaces C of the multilayer body 2, respectively, and are connected to the end-surface external electrodes 3 provided on both end surfaces C of the multilayer body 2 in the length direction L.

### Lateral-Surface-Exposure Internal Electrode 15B

As illustrated in FIG. 5, each lateral-surface-exposure internal electrode 15B is slightly smaller than the cross section of the multilayer body 2 and is spaced apart from both end surfaces C in the length direction L by a certain distance. Each lateral-surface-exposure internal electrode 15B has a lateral-surface counter portion 15Ba located in a central portion between both lateral surfaces B, and lateral-surface lead-out portions 15Bb extending from the lateral-surface counter portion 15Ba to both lateral surfaces B, respectively. The lateral-surface lead-out portions 15Bb extend to and are exposed at the lateral surfaces B of the multilayer body 2, and are connected to the lateral-surface external electrodes 4 provided on both lateral surfaces B of the multilayer body 2 in the width direction W.

The end-surface counter portion 15Aa and the lateral-surface counter portion 15Ba are opposed to each other to form a capacitor portion. In the following description, the end-surface counter portion 15Aa and the lateral-surface counter portion 15Ba are collectively referred to as a counter portion(s) 15a when it is unnecessary to particularly distinguish from each other. The end-surface lead-out portion 15Ab and the lateral-surface lead-out portion 15Bb are collectively referred to as a lead-out portion(s) 15b when it is unnecessary to particularly distinguish from each other. In the multilayer body 2, a region in which the counter portions 15a are arranged is referred to as a counter region, and a region in which the end-surface lead-out portions 15Ab or the lateral-surface lead-out portions 15Bb are arranged is referred to as a lead-out region.

The dielectric layers 14 include a plurality of first dielectric layers 14A each having thereon the end-surface-exposure internal electrode 15A that is exposed at the end surfaces C and a plurality of second dielectric layers 14B each having thereon the lateral-surface-exposure internal electrode 15B that is exposed at a portion of the lateral surfaces B. The first dielectric layers 14A and second dielectric layers 14B are alternately laminated with each other.

### Outer Layer Portion 12

Referring back to FIGS. 2 and 3, the outer layer portions 12 each include a dielectric layer having a constant thickness and are disposed on the sides of the inner layer portion 11 that are adjacent to the main surfaces A. The outer layer portions 12 are made of the same material as that of the dielectric layers 14 of the inner layer portion 11.

### End-Surface External Electrode 3

The end-surface external electrodes 3 are respectively disposed on both end surfaces C of the multilayer body 2. Each end-surface external electrode 3 is connected to the end-surface lead-out portions 15Ab of the end-surface-exposure internal electrodes 15A. Each end surface external electrode 3 covers not only the end surface C but also a portion of each main surface A and a portion of each lateral surface B that are adjacent to the end surface C.

### Lateral-Surface External Electrode 4

The lateral-surface external electrodes 4 are respectively disposed on both lateral surfaces B of the multilayer body 2. Each lateral-surface external electrode 4 is connected to the lateral-surface lead-out portions 15Bb of the lateral-surface-exposure internal electrodes 15B. Each lateral-surface external electrode 4 covers not only a portion of the lateral surface B but also a portion of each main surface A adjacent to the lateral surface B.

The end-surface external electrodes 3 and the lateral-surface external electrodes 4 each include a base electrode layer 31 and a plated layer 32 formed on the base electrode layer 31. The plated layer 32 includes a nickel (Ni) plated layer 321 formed on the base electrode layer 31 and a tin (Sn) plated layer 322 formed on the Ni plated layer 321.

### Lateral-Surface-Exposure Auxiliary Internal Electrode 16A

As shown in FIGS. 3 and 4, in the first example embodiment, lateral-surface-exposure auxiliary internal electrodes 16A as auxiliary internal electrodes 16 are disposed on each first dielectric layer 14A having the end-surface-exposure internal electrode 15A disposed thereon. Each lateral-surface-exposure auxiliary internal electrode 16A is disposed on a portion adjacent to the lateral side B at which the end-surface-exposure internal electrode 15A is not exposed.

Each lateral-surface-exposure auxiliary internal electrode 16A is disposed on a substantially central portion in the length direction L, has a predetermined dimension in the length direction L, and is spaced apart from the end-surface-exposure internal electrode 15A. Each lateral-surface-exposure auxiliary internal electrode 16A is exposed at the lateral surface B and is opposed to the lateral-surface lead-out portion 15Bb of the lateral-surface-exposure internal electrode 15B, which is the internal electrode 15 different from and adjacent in the lamination direction T to the end-surface-exposure internal electrode 15A.

### Dimension d₁ of Lateral-Surface-Exposure Auxiliary Internal Electrode 16A

As illustrated in FIG. 3, each lateral-surface-exposure auxiliary internal electrode 16A has a dimension d₁ in the width direction W that satisfies a relationship expressed as D₁/5<d₁<4D₁/5, where D₁ is a dimension in the width direction W from the lateral surface B to an edge of the end-surface-exposure internal electrode 15A close to the lateral surface B.

When the lateral-surface-exposure auxiliary internal electrode 16A and an end-surface-exposure auxiliary internal electrode 16B of a second example embodiment (to be described later) are collectively referred to as the auxiliary internal electrode(s) 16, the dimension of the auxiliary internal electrode 16 in the width direction W is denoted by d, and the dimension in the width direction W from one surface to an edge of the internal electrode 15 close to the one surface is denoted by D.

### Through Hole 16h

Each lateral-surface-exposure auxiliary internal electrode 16A has a plurality of through holes 16h penetrating therethrough in the lamination direction T. The same dielectric as the material of the dielectric layers 14 is disposed in the through holes 16h.

In a case where each lateral-surface-exposure auxiliary internal electrode 16A is divided into a near-lateral-surface region 16a that is close to the lateral surface B with respect to the center of the lateral-surface-exposure auxiliary internal electrode 16A in the width direction W and a near-center region 16b that is close to the end-surface-exposure internal electrode 15A, the through holes 16h are formed in the near-center region 16b. However, the through holes 16h preferably are formed in at least the near-center region 16b, and may be provided in the near-lateral-surface region 16a. In the latter case, the number of the through holes 16h in the near-center region 16b is preferably greater than the number of the through holes 16h in the near-lateral-surface region 16a.

### Dimension r of Through Hole 16h

The plurality of through holes 16h include one or more, preferably two or more through holes 16h whose dimension r in the width direction W satisfies a relationship represented as d₁/200≤r≤d₁/5 in the near-center region 16b.

### Method of Manufacturing Multilayer Ceramic Capacitor 1

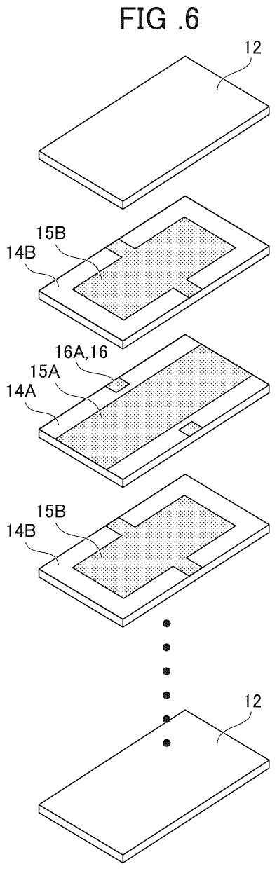

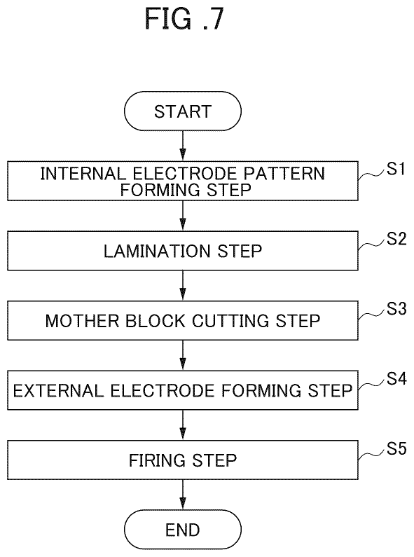

Next, a non-limiting example of a method of manufacturing the multilayer ceramic capacitor 1 according to the example embodiment will be described. FIG. 6 is a diagram illustrating a step of producing the multilayer body 2, included in the method of manufacturing the multilayer ceramic capacitor 1. FIG. 7 is a flowchart illustrating the method of manufacturing the multilayer ceramic capacitor 1.

### Internal Electrode Pattern Forming Step S1

A conductive paste is applied to each of ceramic green sheets that are to form the first dielectric layers 14A to thereby form the end-surface-exposure internal electrode 15A and the lateral-surface-exposure auxiliary internal electrodes 16A. Likewise, the conductive paste is applied to each of ceramic green sheets that are to form the second dielectric layers 14B to thereby form the lateral-surface-exposure internal electrode 15B.

Each ceramic green sheet is a strip-shaped sheet prepared by forming, on a carrier film, a ceramic slurry including ceramic powder, a binder, and a solvent into a sheet shape by using a die coater, a gravure coater, a micro-gravure coater, or the like.

The end-surface-exposure internal electrode 15A, the lateral-surface-exposure internal electrode 15B, and the lateral-surface-exposure auxiliary internal electrode 16A are formed by way of, for example, printing such as screen printing, gravure printing, relief printing, or the like.

The lateral-surface-exposure auxiliary internal electrode 16A having the through holes 16h may be formed from a printed pattern of the lateral-surface-exposure auxiliary internal electrode 16A having the through holes 16h formed in advance, simultaneously with the end-surface-exposure internal electrode 15A.

Alternatively, the through holes 16h of the lateral-surface-exposure auxiliary internal electrode 16A may be formed at the time of sintering the ceramic green sheet having thereon the end-surface-exposure internal electrode 15A and the lateral-surface-exposure auxiliary internal electrode 16A, which have been printed in this order using an ink having a predetermined viscosity and an ink having a viscosity lower than the predetermined viscosity, respectively.

Alternatively, the through holes 16h of the lateral-surface-exposure auxiliary internal electrode 16A may be formed at the time of sintering the ceramic green sheet having thereon the end-surface-exposure internal electrode 15A and the lateral-surface-exposure auxiliary internal electrode 16A, which have been printed in this order using an ink having a predetermined metal content and an ink having a metal content lower than the predetermined metal content, respectively.

Alternatively, the through holes 16h of the lateral-surface-exposure auxiliary internal electrode 16A may be formed at the time of sintering the ceramic green sheet having thereon the end-surface-exposure internal electrode 15A and the lateral-surface-exposure auxiliary internal electrode 16A, which have been printed in this order using an ink including a metal having a predetermined particle size and an ink including a metal having a different particle size, respectively.

### Lamination Step S2

The ceramic sheets for forming the first dielectric layers 14A, each of which has the end-surface-exposure internal electrode 15A disposed thereon, are alternately laminated with the ceramic sheets for forming the second dielectric layers 14B, each of which has the lateral-surface-exposure internal electrode 15B disposed thereon. Subsequently, on the upper and lower sides of the resultant laminate, ceramic green sheets for forming the outer layer portions are disposed, and thermocompression bonding is performed, thereby forming a mother block.

### Mother Block Cutting Step S3

Next, the mother block is cut and divided in the length direction L and the width direction W to produce a plurality of multilayer bodies 2 having a rectangular parallelepiped shape.

### External Electrode Forming Step S4

Next, the end-surface external electrodes 3 are formed on both end surfaces C of the multilayer body 2, and the lateral-surface external electrodes 4 are formed on both lateral surfaces B of the multilayer body 2. The end-surface lead-out portions 15Ab of the end-surface-exposure internal electrodes 15A are connected to the end-surface external electrodes 3. Each end-surface external electrode 3 is formed so as to cover not only the end surface C but also a portion of each main surface A and a portion of each lateral surface B that are adjacent to the end surface C. The lateral-surface lead-out portions 15Bb of the lateral-surface-exposure internal electrodes 15B are connected to the lateral-surface external electrodes 4. Each lateral-surface external electrode 4 is formed so as to cover not only a portion of the lateral surface B but also a portion of each main surface A that is adjacent to the lateral surface B.

### Firing Step S5

Thereafter, heating is performed for a predetermined time in a nitrogen atmosphere at a set firing temperature. As a result, the end-surface external electrodes 3 and the lateral-surface external electrodes 4 are fired onto the multilayer body 2, thereby manufacturing the multilayer ceramic capacitor 1 illustrated in FIG. 1.

### Effect of Auxiliary Internal Electrode 16

In general, in a multi-terminal multilayer ceramic capacitor such as a multilayer ceramic capacitor having a three-terminal structure, the directions in which the internal electrodes extend are different from one layer to another. In a case where the auxiliary internal electrodes 16 as in the example embodiment are not provided, each lead-out region will be in a state where one of the adjacent layers has thereon the lead-out portion disposed as the internal electrode, whereas the other does not have the internal electrode disposed thereon. Therefore, during sintering, the layers will experience different amounts of shrinkage in each lead-pout region, resulting in a large difference in internal stress between the layers. This will make it more likely for peeling-off of one layer from another to be caused.

In contrast, in the first example embodiment, the lateral-surface-exposure auxiliary internal electrodes 16A as the auxiliary internal electrodes 16 are disposed on each first dielectric layer 14A having thereon the end-surface-exposure internal electrode 15A such that each lateral-surface-exposure auxiliary internal electrode 16A is disposed on a portion adjacent to the lateral side B at which the end-surface-exposure internal electrode 15A is not exposed.

Consequently, in each lead-out region, one of the adjacent layers has the lead-out portion 15b disposed thereon, and the other has the auxiliary internal electrode 16 disposed thereon. In other words, in each lead-out region, the internal electrodes are disposed on both of the dielectric layers 14 adjacent to each other. As a result, the difference in amounts of shrinkage between the layers is reduced at the time of sintering, the difference in internal stress decreases, and the likelihood of peeling-off of one layer from another is reduced.

### Effect of Dimension d₁ of Auxiliary Internal Electrode 16

The auxiliary internal electrode 16 has a dimension d in the width direction W that satisfies the relationship expressed as D/5<d<4D/5, where D is a dimension in the width direction W from the lateral surface B to an edge of end-surface-exposure internal electrode 15A close to the lateral surface B.

This feature ensures the auxiliary internal electrode 16 a sufficient dimension d in the width direction W, thereby making it possible to more effectively reduce or prevent peeling-off of one layer from another, which can be caused by a difference in internal stress.

### Effect of the Presence of Through Holes 16h

Furthermore, each auxiliary internal electrode 16 has the plurality of through holes 16h penetrating therethrough in the lamination direction T. The same dielectric as the material of the dielectric layers 14 is disposed in the through holes 16h.

The dielectric in the through holes 16h establishes connection between the second dielectric layer 14B and the first dielectric layer 14A, which are both in contact with the auxiliary internal electrodes 16 and which are located toward the first main surface A and the second main surface A, respectively. The dielectric in the through holes 16h functions as an anchor, thereby making it possible to more effectively reduce or prevent the peeling-off of one layer from another, which can be caused by a difference in internal stress.

### Effect of Forming Through Holes 16h in Near-Center Region

In a case where each auxiliary internal electrode 16 is divided into the near-lateral-surface region 16a that is close to the lateral surface B with respect to the center of the auxiliary internal electrode 16 in the width direction W and the near-center region 16b that is close to the end-surface-exposure internal electrode 15A, the through holes 16h are formed in the near-center region 16b.

Accordingly, the anchor effect is exerted in the near-center region 16b, thereby making it possible to more effectively reduce or prevent the peeling-off of one layer from another, which can be caused by a difference in internal stress.

### Effect of Dimension r of Through Hole 16h

The plurality of through holes 16h include, in the near-center region 16b, one or more, preferably two or more through holes 16h whose dimension r in the width direction W satisfies the relationship represented as d₁/200≤r≤d₁/5. Here, d₁/200 represents a minimum size of the through hole 16h that can be formed in a grain region. Since the dimension r is equal to or less than d₁/5, two or more through holes 16h can be arranged side by side in the width direction W in the near-center region 16b of the auxiliary internal electrode 16, which has a dimension of d₁/2 in the width direction W, thereby making it possible to more effectively reduce or prevent the peeling-off of one layer from another, which can be caused by a difference in internal stress.

### Second Example Embodiment

Next, a multilayer ceramic capacitor 100 according to a second example embodiment of the present invention will be described.

FIG. 1 applies to the second example embodiment, in common with the first example embodiment. In the following description of the multilayer ceramic capacitor 100 of the second example embodiment, the same or similar components to those of the multilayer ceramic capacitor 1 of the first example embodiment are denoted by the same reference signs, and a description of the same or similar components will be omitted.

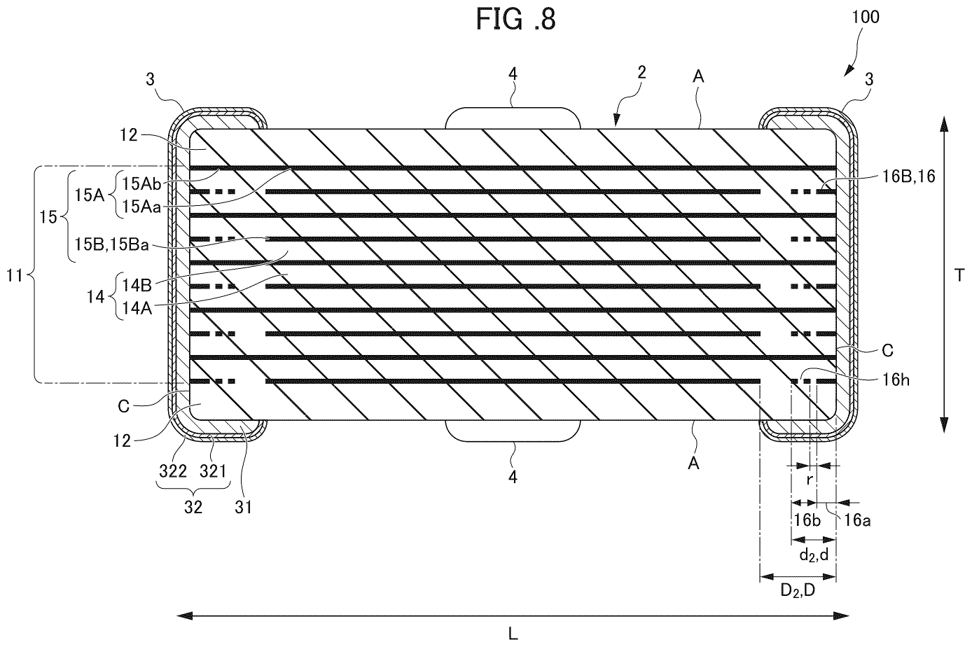

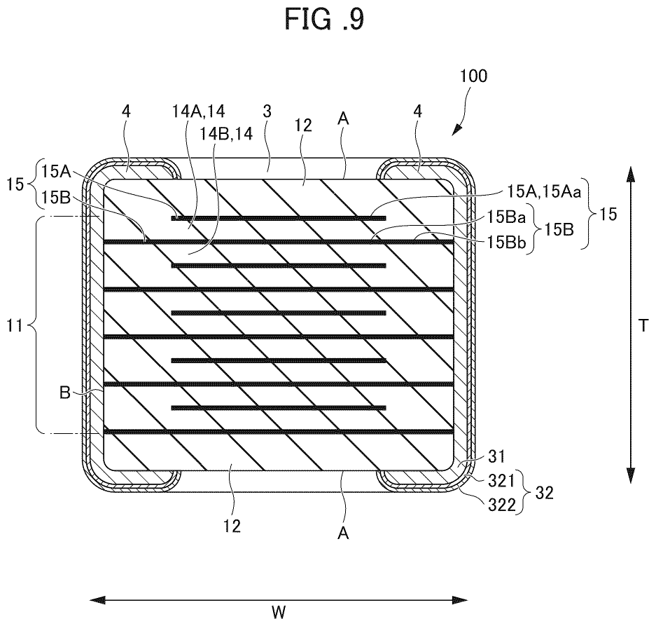

FIG. 8 is a cross-sectional view of the multilayer ceramic capacitor 100 according to the second example embodiment, taken along line II-II in FIG. 1. FIG. 9 is a cross-sectional view of the multilayer ceramic capacitor 100 according to the second example embodiment, taken along the line III-III in FIG. 1.

### Auxiliary Internal Electrode 16

In the first example embodiment, the lateral-surface-exposure auxiliary internal electrodes 16A as the auxiliary internal electrodes 16 are disposed on each first dielectric layer 14A having thereon the end-surface-exposure internal electrode 15A such that each lateral-surface-exposure auxiliary internal electrode 16A is disposed on a portion adjacent to the lateral side B at which the end-surface-exposure internal electrode 15A is not exposed. In contrast, in the second example embodiment, the lateral-surface-exposure auxiliary internal electrodes 16A are not disposed, as illustrated in FIG. 9.

As illustrated in FIG. 8, in the second example embodiment, end-surface-exposure auxiliary internal electrodes 16B as the auxiliary internal electrodes 16 are disposed on each second dielectric layer 14B having thereon the lateral-surface-exposure internal electrode 15B such that each end-surface-exposure auxiliary internal electrode 16B is disposed on a portion adjacent to the end surface C at which the lateral-surface-exposure internal electrode 15B is not exposed.

Each end-surface-exposure auxiliary internal electrode 16B is disposed on a substantially central portion in the width direction W, has a predetermined dimension in the width direction W, and is spaced apart from the lateral-surface-exposure internal electrode 15B. Each end-surface-exposure auxiliary internal electrode 16B is exposed at the end surface C and is opposed to the end-surface lead-out portion 15Ab of the end-surface-exposure internal electrode 15A, which is the internal electrode 15 different from and adjacent in the lamination direction T to the lateral-surface-exposure internal electrode 15B.

Consequently, in each lead-out region, one of the adjacent layers has the lead-out portion 15b disposed thereon, and the other has the end-surface-exposure auxiliary internal electrode 16B disposed thereon. In other words, in each lead-out region, the internal electrodes are disposed on both of the dielectric layers 14 adjacent to each other. As a result, the difference in amounts of shrinkage between the layers is reduced at the time of sintering, the difference in internal stress decreases, and the likelihood of peeling-off of one layer from another is reduced.

### Dimension d₂ of End-Surface-Exposure Auxiliary Internal Electrode 16B

Each end-surface-exposure auxiliary internal electrode 16B has a dimension d₂ in the length direction L that satisfies a relationship expressed as D₂/5<d₂<4D₂/5, where D₂ is a dimension in the length direction L from the end surface C to an edge of the lateral-surface-exposure internal electrode 15B close to the end surface C.

This feature ensures the end-surface-exposure auxiliary internal electrode 16B a sufficient dimension d₂ in the length direction L, thereby making it possible to more effectively reduce or prevent peeling-off of one layer from another, which can be caused by a difference in internal stress.

### Through Hole 16h

Each end-surface-exposure auxiliary internal electrode 16B has a plurality of through holes 16h penetrating therethrough in the lamination direction T. The same dielectric as the material of the dielectric layers 14 is disposed in the through holes 16h.

The dielectric in the through holes 16h establishes connection between the second dielectric layer 14B and the first dielectric layer 14A, which are both in contact with the auxiliary internal electrodes 16 and which are located toward the first main surface A and the second main surface A, respectively. The dielectric in the through holes 16h functions as an anchor, thereby making it possible to more effectively reduce or prevent the peeling-off of one layer from another, which can be caused by a difference in internal stress.

As illustrated in FIG. 8, in a case where each end-surface-exposure auxiliary internal electrode 16B is divided into a near-end-surface region 16a that is close to the end surface C with respect to the center of the end-surface-exposure auxiliary internal electrode 16 in the length direction L and a near-center region 16b that is close to the lateral-surface-exposure internal electrode 15B, the through holes 16h are formed in the near-center region 16b.

However, the through holes 16h are preferably provided in at least the near-center region 16b, and may be provided in the near-end-surface region 16a. In the latter case, the number of the through holes 16h in the near-center region 16b is preferably greater than the number of the through holes 16h in the near-end-surface region 16a.

Accordingly, an anchor effect is exerted in the near-center region 16b, thereby making it possible to more effectively reduce or prevent the peeling-off of one layer from another, which can be caused by a difference in internal stress.

### Dimension r of Through Holes 16h

The plurality of through holes 16h include, in the near-center region 16b, one or more, preferably two or more through holes 16h whose dimension r in the length direction L satisfies a relationship represented as d₂/200≤r≤d₂/5.

Here, d₂/200 represents a minimum size of the through hole 16h that can be formed in a grain region. Since the dimension r is equal to or less than d₂/5, two or more through holes 16h can be arranged side by side in the length direction L in the near-center region 16b of the auxiliary internal electrode 16, which has a dimension of d₂/2 in the length direction L.

### Third Example Embodiment

Next, a multilayer ceramic capacitor according to a third example embodiment of the present invention will be described. The multilayer ceramic capacitor 100 of the third example embodiment will be described using the same reference signs as in the first and second example embodiments, and redundant descriptions will be omitted.

In the third example embodiment, likewise to the first example embodiment, lateral-surface-exposure auxiliary internal electrodes 16A as the auxiliary internal electrodes 16 are disposed on each first dielectric layer 14A having thereon the end-surface-exposure internal electrode 15A such that each lateral-surface-exposure auxiliary internal electrode 16A is disposed on a portion adjacent to the lateral side B at which the end-surface-exposure internal electrode 15A is not exposed.

Moreover, similar to the second example embodiment, end-surface-exposure auxiliary internal electrodes 16B as the auxiliary internal electrodes 16 are disposed on each second dielectric layer 14B having thereon the lateral-surface-exposure internal electrode 15B such that each end-surface-exposure auxiliary internal electrode 16B is disposed on a portion adjacent to the end surface C at which the lateral-surface-exposure internal electrode 15B is not exposed.

Thus, the third example embodiment achieves not only the advantageous effects of the first example embodiment but also the advantageous effects of the second example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers laminated in a lamination direction and each having an internal electrode disposed thereon, the multilayer body including two main surfaces respectively provided on both sides in the lamination direction, two lateral surfaces respectively provided on both sides in a width direction intersecting with the lamination direction, and two end surfaces respectively provided on both sides in a length direction intersecting with the lamination direction and the width direction;
end-surface external electrodes respectively provided on the end surfaces of the multilayer body; and
lateral-surface external electrodes respectively provided on the lateral surfaces of the multilayer body;
the internal electrode including end-surface-exposure internal electrodes exposed at the end surfaces, and lateral-surfaces-exposure internal electrodes exposed at the lateral surfaces, each of the end-surface-exposure internal electrodes including a counter portion and a lead-out portion that extends from the counter portion, each of the lateral-surface-exposure internal electrodes including a counter portion and a lead-out portion that extends from the counter portion, the counter portion of the end-surface-exposure internal electrode and the counter portion of the lateral-surface-exposure internal electrode being opposed to each other;
the dielectric layers including first dielectric layers each including the end-surface-exposure internal electrode thereon, and second dielectric layers each including the lateral-surface-exposure internal electrode thereon, the first dielectric layers and the second dielectric layers being alternately laminated with each other; wherein
at least one of each first dielectric layer or each second dielectric layer includes an auxiliary internal electrode on a portion adjacent to at least one of the lateral surface or the end surface at which the internal electrode on the at least one of each first dielectric layer or each second dielectric layer is not exposed;
the auxiliary internal electrode is spaced apart from the internal electrode on the at least one of each first dielectric layer or each second dielectric layer, is exposed at the at least one of the lateral surface or the end surface, and is opposed to the lead-out portion of the internal electrode that is different from and adjacent in the lamination direction to the internal electrode on the at least one of each first dielectric layer or each second dielectric layer;
the auxiliary internal electrode includes a through hole which penetrates through the auxiliary internal electrode in the lamination direction and in which a same dielectric as that of the dielectric layers is provided, and the dielectric in the through hole establishes connection between the dielectric layers that are in contact with the auxiliary internal electrode and that are respectively located toward the two main surfaces.

2. The multilayer ceramic capacitor according to claim 1, wherein the auxiliary internal electrode is provided on each first dielectric layer.

3. The multilayer ceramic capacitor according to claim 1, wherein the auxiliary internal electrode is provided on each second dielectric layer.

4. The multilayer ceramic capacitor according to claim 1, wherein
in a case where the auxiliary internal electrode is divided, with respect to a center in a direction from the at least one of the lateral surface or the end surface at which the auxiliary internal electrode is exposed to the internal electrode, into a near-lateral-surface region that is at or adjacent to the lateral surface and a near-center region that is at or adjacent to the internal electrode, the through hole is in the near-center region.

5. The multilayer ceramic capacitor according to claim 1, wherein
a dimension in a direction parallel to the width direction or the length direction and from the at least one of the lateral surface or the end surface at which the auxiliary internal electrode is exposed to an edge of the internal electrode at or adjacent to the at least one of the lateral surface or the end surface is defined as D, a dimension of the auxiliary internal electrode in the direction parallel to the width direction or the length direction and from the at least one of the lateral surface or the end surface toward the internal electrode is defined as d; and
a relationship expressed as D/5<d<4D/5 is satisfied.

6. The multilayer ceramic capacitor according to claim 1, wherein
the through hole of the auxiliary internal electrode includes a through hole that has a maximum dimension r in a direction parallel to the width direction or the length direction and from the at least one of the lateral surface or the end surface at which the auxiliary internal electrode is exposed toward the internal electrode; and
the maximum dimension r satisfies a relationship expressed as d/200≤r≤d/5.

7. The multilayer ceramic capacitor according to claim 1, wherein the multilayer ceramic capacitor has a three terminal structure.

8. The multilayer ceramic capacitor according to claim 1, wherein the multilayer body includes rounded corners and ridges.

9. The multilayer ceramic capacitor according to claim 1, wherein each of the end surface external electrodes and the lateral surface external electrodes includes a base electrode layer and a plated layer.

10. The multilayer ceramic capacitor according to claim 9, wherein the base electrode layer includes nickel and the plated layer includes tin.

11. The multilayer ceramic capacitor according to claim 1, wherein a plurality of the through hole is provided in each of the auxiliary internal electrodes.

12. The multilayer ceramic capacitor according to claim 11, wherein the same dielectric as that of the dielectric layers is provided in each of the plurality of the through hole.

13. The multilayer ceramic capacitor according to claim 11, wherein
the plurality of the through hole includes two or more through holes each with a maximum dimension r in a direction parallel to the width direction or the length direction and from the at least one of the lateral surface or the end surface at which the auxiliary internal electrode is exposed toward the internal electrode; and
the maximum dimension r satisfies a relationship expressed as d/200≤r≤d/5.

14. The multilayer ceramic capacitor according to claim 1, wherein the auxiliary internal electrode is a lateral-surface-exposure auxiliary internal electrode.

15. The multilayer ceramic capacitor according to claim 14, wherein
a dimension in a direction parallel to the width direction or the length direction and from the at least one of the lateral surface or the end surface at which the auxiliary internal electrode is exposed to an edge of the internal electrode at or adjacent to the at least one of the lateral surface or the end surface is defined as D, a dimension of the auxiliary internal electrode in the direction parallel to the width direction or the length direction and from the at least one of the lateral surface or the end surface toward the internal electrode is defined as d; and
a relationship expressed as D/5<d<4D/5 is satisfied.

16. The multilayer ceramic capacitor according to claim 1, wherein the auxiliary internal electrode is an end-surface-exposure auxiliary internal electrode.

17. The multilayer ceramic capacitor according to claim 16, wherein
a dimension in a direction parallel to the width direction or the length direction and from the at least one of the lateral surface or the end surface at which the auxiliary internal electrode is exposed to an edge of the internal electrode at or adjacent to the at least one of the lateral surface or the end surface is defined as D, a dimension of the auxiliary internal electrode in the direction parallel to the width direction or the length direction and from the at least one of the lateral surface or the end surface toward the internal electrode is defined as d; and
a relationship expressed as D/5<d<4D/5 is satisfied.

18. The multilayer ceramic capacitor according to claim 1, wherein the auxiliary internal electrode includes an end-surface-exposure auxiliary internal electrode and a lateral-surface-exposure auxiliary internal electrode.
